(19) United States
(12) Patent Application Publication
(10) Pub. No.: US 2004/0247014 A1
(43) Pub. Date: Dec. 9, 2004

(54) Methods and apparatus for indicating temperature-related events

(76) Inventors: John P. Vache, Redmond, WA (US); John Conrard, Redmond, WA (US)

Correspondence Address: Randy J. Pritzker, Wolf, Greenfield & Sacks, P.C., 600 Atlantic Avenue, Boston, MA, 02210, US

(21) Appl. No.: 10/812,862

(22) Filed: Mar. 30, 2004

Related U.S. Application Data
(60) Provisional application No. 60/467,790, filed on May 2, 2003.

(51) Int. Cl. G01K 13/12

(52) U.S. Cl. 374/100

(57) ABSTRACT

The present invention relates to reliable and accurate techniques and devices for detecting and indicating temperature-related conditions and events associated with various items such as foods and medicines.

### CROSS-REFERENCE TO RELATED APPLICATION

This application claims the benefit of U.S. Provisional Application Serial No. 60/467,790, filed May 2, 2003 entitled “Methods and Apparatus for Indicating Temperature-Related Events.” The entire disclosure of the aforementioned application is hereby incorporated herein by reference.

### FIELD OF THE INVENTION

The present invention relates generally to detecting and indicating temperature-related conditions and events in connection with various items.

### BACKGROUND

For certain perishable and/or consumable products, it is often useful, and in some cases critical, to know if the product has passed through a particular temperature barrier. Many products typically are transported in some form of a “supply-chain” from the product manufacturer/source to a purchaser or end-user. During transportation in such a supply-chain, which may include several links and involve significant time periods (transport via land, sea and/or air, storage in one or more warehouses, etc.), products may be exposed to a wide variety of environmental conditions, some of which may cause degradation of, or damage to, the product. In some instances, it is not entirely necessary to know when an adverse environmental condition occurred; rather, in many cases, to make a useful evaluation relating to product quality/safety/effectiveness, etc., it is enough to know merely that an adverse condition occurred at some point.

For various products intended for human use or consumption (e.g., foods and food-related products, beverages, medicines, cosmetics, etc.), it is particularly useful to know if a given product has been exposed to undesirable temperature conditions (e.g., inadvertent freezing or thawing, extreme heat or cold, time spent outside of a particular desirable temperature range, undesirable temperature cycles or fluctuations, etc.). Such exposures can result in significant health and/or safety consequences; in some cases, products that are exposed to undesirable temperature conditions may be deemed unsafe for human consumption/use. More generally, for other products not necessarily intended for human use or consumption, information relating to the exposure of a product to various environmental conditions, including undesirable temperature conditions, may nonetheless be important in determining the quality of the product (e.g., usefulness, effectiveness, shelf life, etc.).

Information relating to various exposure conditions may be especially important in connection with medicines and other health-related products. For example, some vaccines intended for injection-into humans become ineffective if the vaccine has been frozen. While some sophisticated techniques of detecting whether a vaccine has been frozen are available, the problem of potentially frozen vaccines is exacerbated in several scenarios in which sophisticated techniques are not readily available. In particular, in several locations around the world (e.g., at least some third world countries and other locations), computers, electronics, and other sophisticated equipment may not be readily available to determine whether or not potentially life-saving vaccines have been frozen. In these situations, it is possible that many humans could be unknowingly administered ineffective and perhaps dangerous medicines.

### SUMMARY

In view of the foregoing, Applicants have recognized and appreciated that inexpensive, convenient, reliable and accurate techniques for detecting and indicating temperature-related conditions and events in connection with various products/items would be extremely useful and valuable, especially in connection with foods and medicines such as vaccines. Accordingly, various embodiments of the present invention are directed to methods and apparatus for providing such information in this manner.

For example, one embodiment of the present invention is directed to a method for indicating if a vaccine has been frozen. The method of this embodiment comprises an act of associating at least one breakable component with the vaccine, wherein the breakable component is configured to break upon an occurrence of a freezing condition of the vaccine. In one aspect, such a breakage provides an irreversible indication to an observer that the vaccine has been exposed to a freezing condition at some point. In another aspect of this embodiment, the breakable component is enclosed in a small and at least partially transparent housing which may be safely and conveniently placed with the vaccine (e.g., the vaccine may be disposed in one or more vials contained in a protective package, and the small housing enclosing the breakable component may be included together with the vaccine vials in the protective package). In yet another aspect of this embodiment, the breakable component may include a fuse that shatters upon exposure to freezing conditions, wherein the shattered fuse may be easily observed through the transparent housing.

Another embodiment of the invention is directed to a temperature event indicator. The indicator of this embodiment includes an at least partially transparent housing, and a bimetallic disk disposed in the housing. The bimetallic disk is adapted to change its physical form based at least in part on an exposure to a predetermined temperature condition. The housing also contains a glass fuse arranged with respect to the bimetallic disk such that at least one change in the physical form of the bimetallic disk causes the glass fuse to break. The breakage of the glass fuse provides an irreversible indication to an observer that the bimetallic disk was exposed to the predetermined temperature condition. In various aspects, the predetermined temperature condition may include, but is not limited to, a freezing condition, a thawing condition, exposure to a particular temperature or range of temperatures, exposure to particular temperatures or temperature ranges for predetermined time periods, etc.

More generally, other embodiments of the invention are directed to methods and apparatus for indicating a temperature-related event for a variety of items and in a variety of scenarios by employing at least one breakable element or component.

For example, one embodiment of the invention is directed to an apparatus, comprising at least one first element adapted to change its physical form based at least in part on a predetermined temperature condition, and at least one second element arranged with respect to the at least one first element such that at least one change in the physical form of the first element causes the second element to break.

Similarly, another embodiment of the invention is directed to a method of indicating a temperature event associated with at least one item. The method comprises an act of associating at least one breakable component with the at least one item, wherein the at least one breakable component is configured to break upon an occurrence of the temperature event.

It should be appreciated the all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter.

Additionally, for purposes of this disclosure, the term “fuse” is used to indicate a filament-like element that is configured to break upon the occurrence of a particular condition/event. Fuses often are thought of in terms of electrical applications, in which an electrical current exceeding a particular threshold causes a wire filament to essentially disintegrate. Fuses also are thought of in terms of a cord or string of readily combustible material that is lighted at one end to carry a flame along its length (e.g., to an explosive at the other end of the fuse). In this disclosure, the term “fuse” is used more generally as defined above. As discussed in greater detail below, one example of a fuse contemplated by the present invention is a glass pipette, which may be shattered on impact by a sufficient force. Of course, it should be appreciated that the invention is not limited in this respect, as other types of fuses may be suitable for purposes of the present invention.

### BRIEF DESCRIPTION OF THE DRAWINGS

FIG. 1 is a diagram showing three views of a temperature event indicator according to one embodiment of the invention;

FIG. 2 is a diagram illustrating three views of a first transparent component of the housing of the apparatus shown in FIG. 1;

FIG. 3 is a diagram illustrating three views of a second component of the housing that mates with the first component;

FIG. 4 provides various illustrations of a glass fuse used in the indicator shown in FIG. 1;

FIG. 5 is a diagram illustrating three views of a bimetallic disk used in the indicator shown in FIG. 1; and

FIG. 6 is an exploded view illustrating an indicator similar to that shown in FIG. 1 equipped with an arming mechanism, according to one embodiment of the invention.

### DETAILED DESCRIPTION

Following below are more detailed descriptions of various concepts related to, and embodiments of, methods and apparatus according to the present invention for detecting and indicating temperature-related conditions and events in connection with various items. It should be appreciated that various aspects of the invention, as discussed above and outlined further below, may be implemented in any of numerous ways, as the invention is not limited to any particular manner of implementation. Examples of specific implementations are provided for illustrative purposes only.

One embodiment of the invention is directed to a low cost device which records a temperature event by accurately and irreversibly reacting to a predetermined temperature condition. The device of this embodiment employs a calibrated bimetallic disk that changes configuration upon exposure to a predetermined temperature condition. In various aspects, the disk can be configured to react to a variety of temperature conditions, including those involving relatively high temperatures or low temperatures. The device of this embodiment also includes a glass fuse arranged in proximity to the disk. Upon changing configuration, the disk impacts the glass fuse and causes the fuse to shatter, thereby irreversibly recording an event related to the predetermined temperature condition.

According to various aspects of this embodiment, the device has a minimal number of parts so that it is easily and inexpensively manufactured, and conveniently and safely deployed with any number of products or items so as to reliably record temperature event-related information. In yet another aspect, the device is configured to be essentially “self-arming” when attached or otherwise associated with the product(s)/item(s) to be monitored; in this manner, the device may be easily deployed in a number of scenarios to conveniently and inexpensively provide important temperature-related information.

For example, according to other embodiments of the invention, a device as discussed above and described in greater detail below may be used to determine various temperature-related conditions (e.g., freezing or thawing) in connection with a variety of items intended for human use or consumption, such as foods and medicines. In particular, one embodiment of the invention is directed to a method for determining and indicating if a vaccine has been frozen, by placing an indicator device based on the various concepts discussed herein in sufficient proximity to the vaccine (e.g., in a package together with one or more vials of the vaccine). As the vaccine is shipped from place to place (e.g., the laboratory in which it was created, various suppliers/medical institutions and carriers, and ultimately to a point of use), the presence of the indicator together with the vaccine facilitates a convenient determination of whether or not the vaccine has been frozen, and hence possibly ineffective.

It should be appreciated that the foregoing provides merely one illustrative exemplary application of the various concepts discussed herein, and that the present invention is not limited to this example. More generally, as discussed above, various apparatus according to the present invention may be used to provide temperature-related information regarding a wide variety of products. Some examples of such temperature-related information include, but are not limited to, freezing conditions, thawing conditions, exposure to a particular temperature or range of temperatures, exposure to particular temperatures or temperature ranges for predetermined time periods, exposure to temperatures above or below a particular temperature range, exposure to temperatures above or below a particular temperature range for predetermined time periods, etc.

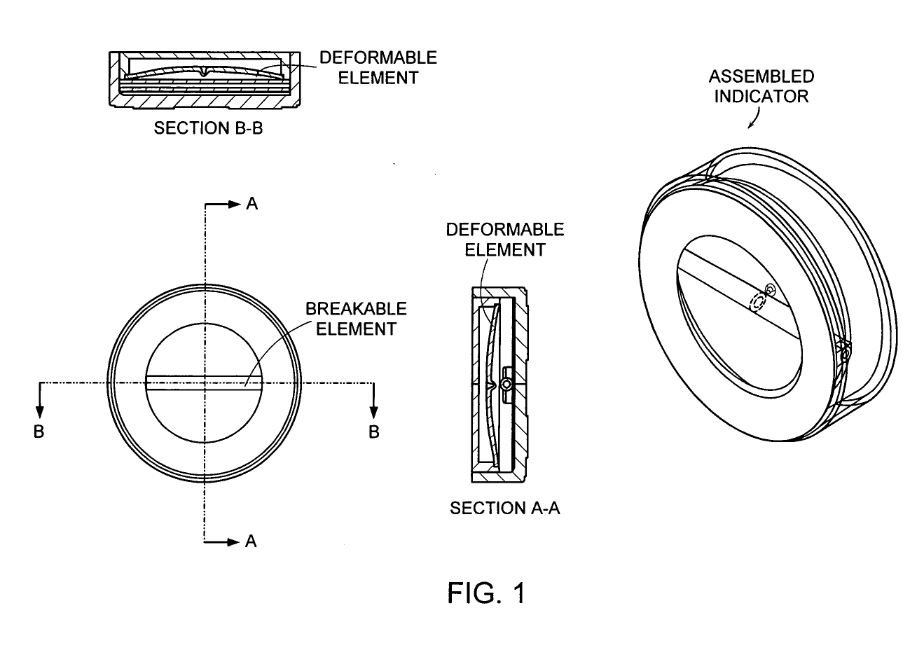

FIG. 1 is a diagram showing three views of a temperature event indicator according to one embodiment of the invention. As illustrated in FIG. 1, the indicator includes an at least partially transparent two-piece housing that encloses a bimetallic disk and a glass fuse. The bimetallic disk is particularly configured in composition and structure to change its physical form when the indicator is exposed to a predetermined temperature condition. Upon changing form, at least a portion of the disk impacts and shatters the glass fuse. The shattered glass fuse, which is safely contained within the housing, provides an irreversible indication of the temperature condition.

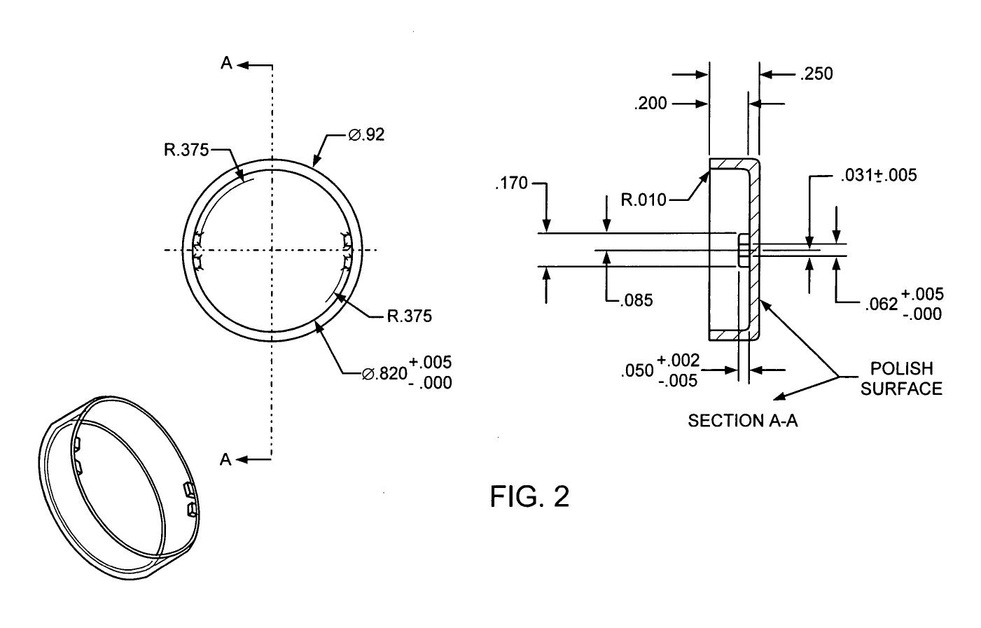

FIG. 2 is a diagram illustrating three views of a first transparent component of the housing of the apparatus shown in FIG. 1. All dimensions shown in FIG. 2, as well as the other is figures, are in inches. As can be seen from FIG. 2, the transparent housing component has a generally flat and disk-like shape, and includes a pair of diametrically opposed support mechanisms for supporting the glass fuse in place when the device is assembled. FIG. 2 also illustrates that a diameter of the housing is less than one inch, and that a thickness of the housing is on the order of one-quarter of an inch. Hence, the indication device is small, lightweight, and conveniently deployed.

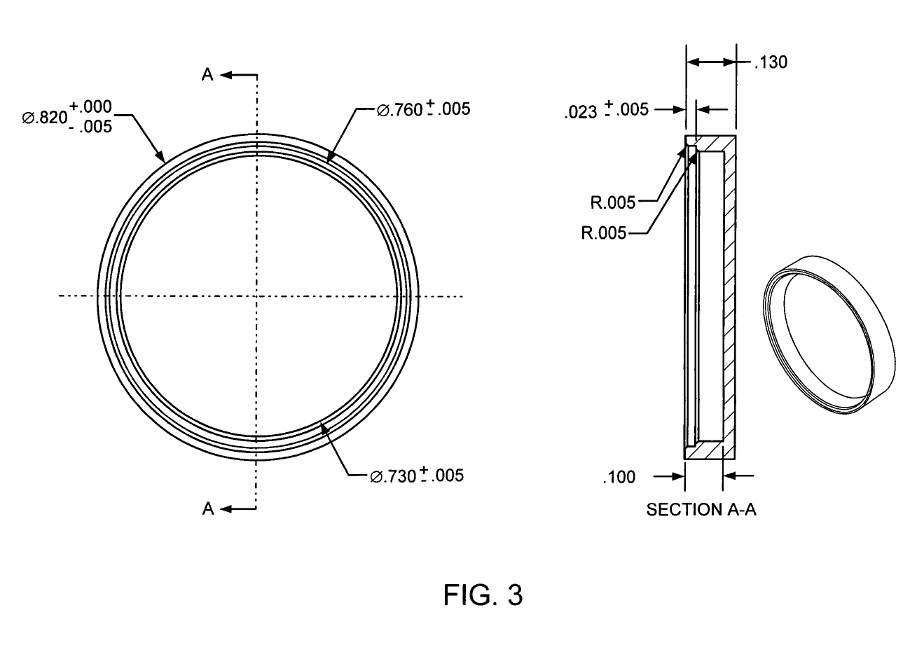

FIG. 3 is a diagram illustrating three views of a second component of the housing that mates with the first component. The second component need not be transparent, as the first component provides the transparency that permits inspection by an observer of the condition of the glass fuse. As can be seen from FIG. 3, the second component of the housing includes a ledge around its diameter for supporting the bimetallic disk. FIG. 3 also illustrates that the diameter of the second component is less than that of the first component; accordingly, the second component fits into the first component (the first component acts as a sleeve for the second component) to form the housing.

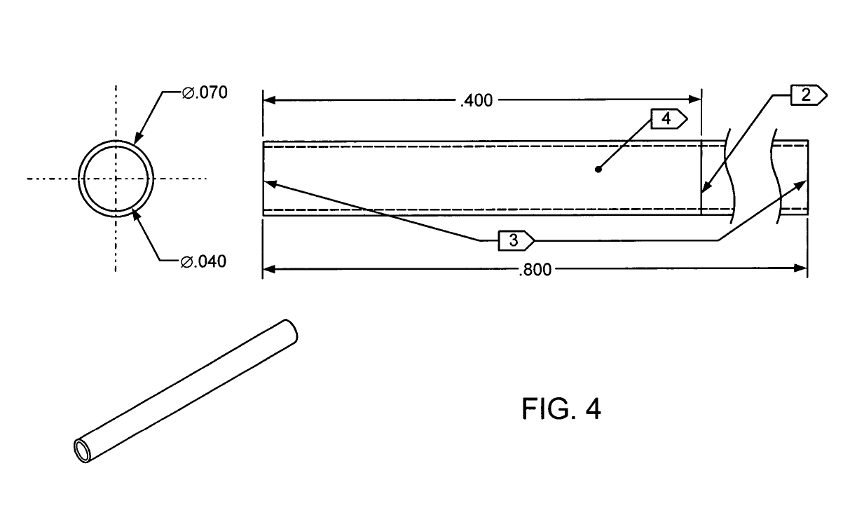

FIG. 4 provides various illustrations of the glass fuse used in the indicator of FIG. 1. As indicated in FIG. 4, according to one aspect, the glass fuse is particularly scored, and additionally may be particularly colored to facilitate quick observation of the fuse and determination of a temperature-related event. Specifically, a viewer may more easily detect a colored fuse if the fuse is still in tact; once the fuse shatters, the color typically is significantly less detectable, if at all. While the color “red” is indicated in FIG. 4, it should be appreciated that the invention is not limited in this respect, as the fuse may have any of a variety of colors.

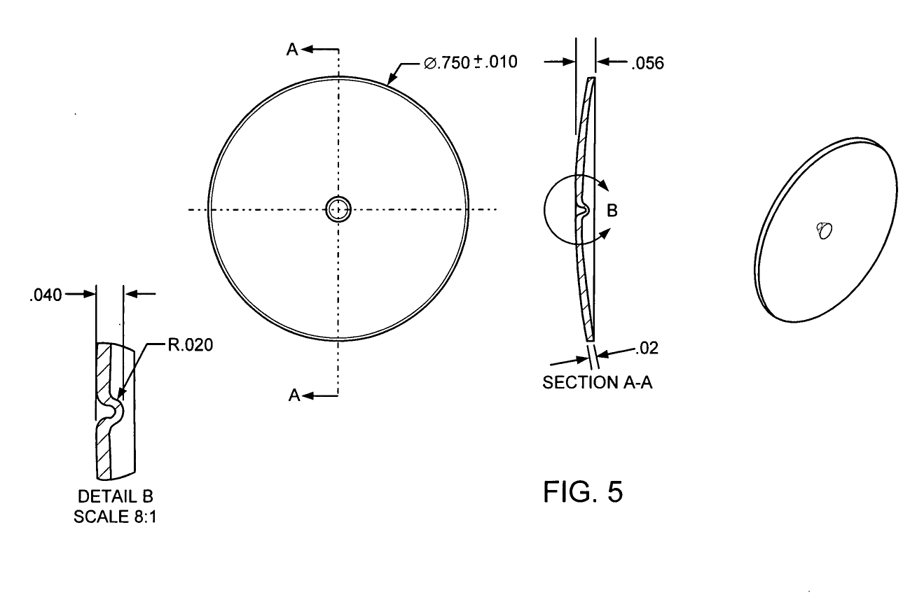

FIG. 5 is a diagram illustrating three views of the bimetallic disk used in the indicator of FIG. 1. In general, bimetallic elements change shape rapidly as a result of being exposed to particular temperature conditions. Typically, a bimetallic element is created by bonding one metal or alloy to another metal or alloy, where the two metals/alloys have different coefficients of thermal expansion. As a result, the element is forced to somehow deform (e.g., bend) to relieve pressure caused by the different rates of expansion of the respective bonded materials. The performance of a bimetallic element may be tailored to be responsive to a particular predetermined temperature condition at least in part via selection of the constituent metals/alloys based on their respective coefficients of expansion. The performance of the elements also may be tailored based on a particular shape or form given to the element.

Bimetallic elements conventionally are used in a variety of common devices, such as thermostats, automatic chokes of automobiles, and automatic appliance controls, such as in coffee pots. Many devices incorporating bimetallic elements, for example thermostats, generally do not permanently record having been exposed to a predetermined temperature condition. Instead, these devices change as the ambient temperature conditions fluctuate with respect to a predetermined temperature condition to which the bimetallic element is responsive. This quality is useful in some situations, but is not useful for permanently recording whether the device has been exposed to the predetermined temperature condition.

With reference again to FIG. 5, the bimetallic disk employed in one embodiment of the present invention is pre-formed to have some convexity/concavity, and further includes a deformation in the form of a protrusion at essentially the center of the disk. In an “unactivated” state (i.e., not a predetermined temperature condition), the disk is seated in the ledge of the second component of the housing (see FIG. 3) such that the disk is concave with respect to the glass fuse once the housing is assembled, wherein the disk protrusion is at an apex of the disk away from the glass fuse. In an “activated” state (i.e., upon exposure to the predetermined temperature condition), the disk changes form (e.g., snaps into a convex position with respect to the glass fuse) such that the protrusion impacts and shatters the glass fuse, thereby permanently recording the event.

According to various embodiments, the bimetallic disk may be particularly configured in composition and structure to facilitate indication of a variety of temperature conditions. Some examples of temperature conditions to which the bimetallic disk may be responsive include, but are not limited to, freezing conditions, thawing conditions, exposure to a particular temperature or range of temperatures, exposure to particular temperatures or temperature ranges for predetermined time periods, exposure to temperatures above or below a particular temperature range, exposure to temperatures above or below a particular temperature range for predetermined time periods, etc.

For example, in one embodiment, the bimetallic disk is particularly configured to change form upon exposure to a freezing condition (e.g., approximately 0° C. or 32° F.), such that the apparatus of FIG. 1 acts as a freeze indicator. In this embodiment, the bimetallic disk is formed from a high thermal expansion alloy and a low thermal expansion alloy that are bonded and rolled together to form the disk. One example of a material suitable for a bimetallic disk according to this embodiment is ASTM Standard B-388, Type TM-2, which refers to an essentially 50/50 composition of a high expansion alloy including 72% Manganese, 18% Copper and 10% Nickel and a low expansion alloy including 36% Nickel and 64% Iron. Bimetallic disks formed of this material are available from Demaich, Inc., 70 Mill Street, Johnston, R.I., 02919, Part No. F030(also see the website www.demaich.com for more information on bimetallic materials).

According to yet another embodiment of the present invention, an indicator similar to that shown in FIG. 1 optionally may be equipped with a mechanism that prevents the indicator from activating even if it is exposed to the predetermined temperature condition. In one aspect, such a feature may be implemented in connection with modifications to the housing of the indicator that permit changes in the proximity of the first element that changes form based on temperature conditions (e.g., a bimetallic disk) to the second breakable element (e.g., a glass fuse). For example, with reference again to FIG. 1, in one embodiment the indicator may have an “unarmed” position in which the housing is configured (e.g., based on the relative positions of the first and second housing components, and/or with the aid of a spring loaded or other resistance mechanism) such that the bimetallic disk is unable to contact the glass fuse even if it is exposed to the predetermined temperature condition and changes form.

According to various aspects of this embodiment, the indicator may be “armed” in any of a number of ways. For example, in one aspect, the indicator may be armed by pressing the two components of the housing together (e.g., with a small force applied by fingers, by pressing the indicator on a surface, etc.) so that the first deformable element is moved in closer proximity to the second breakable element, and is able to impact the breakable element upon changing form.

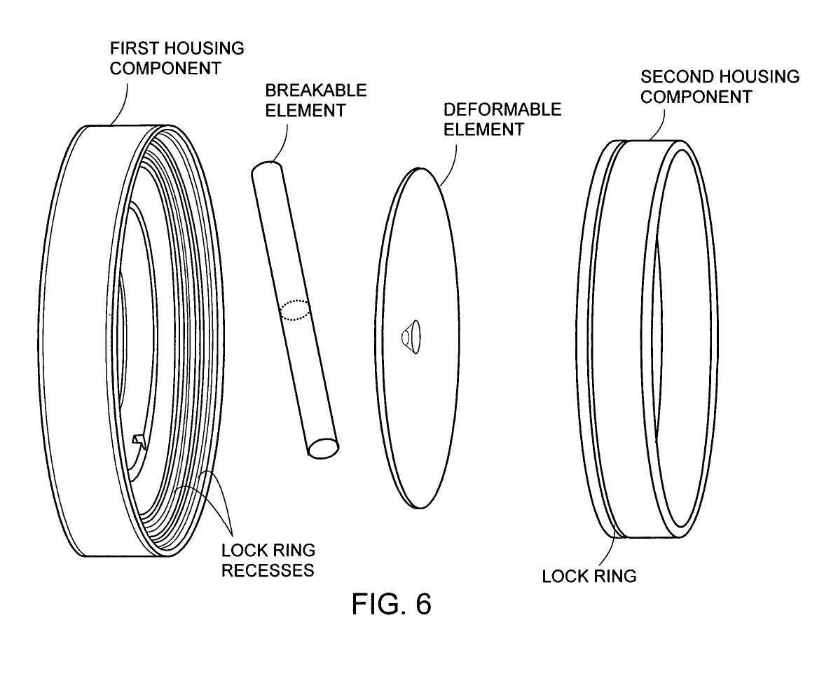

FIG. 6 illustrates one implementation of this concept. As shown in FIG. 6, the second housing component may be equipped with a lock ring which is configured to engage with one or more grooves or recesses formed in the first housing component. Upon initial assembly of the indicator, for example, the lock ring may be configured to engage with a first “outer” recess such that contact between the deformable element (e.g., bimetallic disk) and the breakable element (e.g., glass fuse) is prevented due to the distance between these elements. The indicator may be armed by pressing the two housing components together until the lock ring engages with a second “inner” recess, which brings the deformable and breakable elements in closer proximity. According to one aspect of this embodiment, this arming process is irreversible, as once the lock ring engages with the second inner recess, there is no easy way for a user to pull the two housing components farther apart.

In yet another embodiment of an arming mechanism, the indicator may be armed using a rotational motion in which the two housing components are rotated with respect to each other between armed and unarmed positions. In one implementation based on this aspect, the rotational motion also may cause a movement of the two housing components towards or away from each other along the axis of rotation, resulting in a screw-type motion that adjusts the proximity of the deformable element and the breakable element of the indicator. In this respect, one or both of the housing components may include a threaded mechanism to facilitate such a movement.

In yet another aspect of this embodiment, the indicator may be equipped with an optional locking mechanism to insure that the indicator remains in an armed state once it is armed.

One or more of the foregoing features may facilitate unintentional/unwanted activation, for example, during initial shipment or storage of the indicators before use with products/items for which temperature-related information is desired. It should be appreciated, however, that in other embodiments, the indicator is “automatically” activated, and requires no user action/intervention to be armed so as to provide an indication of a predetermined temperature condition.

Having thus described several illustrative embodiments of the invention, various alterations, modifications, and improvements will readily occur to those skilled in the art. Such alterations, modifications, and improvements are intended to be within the spirit and scope of the invention. While some examples presented herein involve specific combinations of functions or structural elements, it should be understood that those functions and elements may be combined in other ways according to the present invention to accomplish the same or different objectives. In particular, acts, elements and features discussed in connection with one embodiment are not intended to be excluded from a similar or other roles in other embodiments. Accordingly, the foregoing description is by way of example only, and is not intended as limiting.

1. An apparatus, comprising:
at least one first element adapted to change its physical form based at least in part on a predetermined temperature condition; and
at least one second element arranged with respect to the at least one first element such that at least one change in the physical form of the first element causes the second element to break.

2. The apparatus of claim 1, wherein the at least one first element is configured to change its physical form upon significant exposure to the predetermined temperature condition.

3. The apparatus of any of the foregoing claims, wherein the apparatus is configured such that the at least one first element changes its physical form upon significant exposure for a predetermined time period to the predetermined temperature condition.

4. The apparatus of claim 1, wherein the predetermined temperature condition is a freezing condition.

5. The apparatus of claim 4, wherein the freezing condition represents approximately a freezing temperature of water.

6. The apparatus of claim 1, wherein the predetermined temperature condition is a thawing condition.

7. The apparatus of claim 6, wherein the thawing condition represents approximately a melting temperature of ice.

8. The apparatus of claim 1, wherein the predetermined temperature condition relates to a significant exposure of the at least one first element to at least one target temperature.

9. The apparatus of claim 8, wherein the predetermined temperature condition relates to a significant exposure of the at least one first element to the at least one target temperature for a predetermined amount of time.

10. The apparatus of claim 1, wherein the predetermined temperature condition relates to a significant exposure of the at least one first element to at least one temperature above or below a target temperature range.

11. The apparatus of claim 10, wherein the predetermined temperature condition relates to a significant exposure of the at least one first element to at least one temperature above or below the target temperature range for a predetermined amount of time.

12. The apparatus of claim 1, wherein the at least one first element includes at least one bimetallic element.

13. The apparatus of claim 12, wherein the at least one bimetallic element includes a bimetallic disk.

14. The apparatus of claim 13, wherein the bimetallic disk includes at least one deformation, and wherein the apparatus is configured such that the at least one deformation impacts the at least one second element when the bimetallic disk changes form.

15. The apparatus of claim 1, wherein at least a portion of the at least one second element is formed as a breakable fuse.

16. The apparatus of claim 1, wherein at least a portion of the at least one second element is formed as a thermal fuse.

17. The apparatus of claim 1, wherein at least a portion of the at least one second element is formed from glass.

18. The apparatus of claim 1, wherein the at least one second element includes at least one colored element.

19. The apparatus of claim 1, wherein the at least one second element includes at least one glass fuse.

20. The apparatus of claim 19, wherein the at least one glass fuse includes at least one colored glass fuse.

21. The apparatus of claim 1, wherein the apparatus is configured such that a breakage of the at least one second element provides an irreversible indication to an observer that the at least one first element was exposed to the predetermined temperature condition.

22. The apparatus of claim 1, further including a user-operated arming mechanism having at least an unarmed state and an armed state, wherein the apparatus is configured such that, in the unarmed state, the at least one first element is unable to cause the at least one second element to break notwithstanding changes in the physical form of the at least one first element and, in the armed state, the at least one first element is able to cause the at least one second element to break based on at least one change in the physical form of the at least one first element.

23. A temperature event indicator, comprising:
an at least partially transparent housing;
a bimetallic disk disposed in the housing, the bimetallic disk adapted to change its physical form based at least in part on an exposure to a predetermined temperature condition; and
a glass fuse disposed in the housing and arranged with respect to the bimetallic disk such that at least one change in the physical form of the bimetallic disk causes the glass fuse to break, thereby providing an irreversible indication to an observer that the bimetallic disk was exposed to the predetermined temperature condition.

24. The indicator of claim 23, wherein the indicator is configured such that the bimetallic disk changes its physical form upon significant exposure for a predetermined time period to the predetermined temperature condition.

25. The indicator of claim 23, wherein the predetermined temperature condition is a freezing condition.

26. The indicator of claim 25, wherein the freezing condition represents approximately a freezing temperature of water.

27. The indicator of claim 23, wherein the predetermined temperature condition is a thawing condition.

28. The indicator of claim 27, wherein the thawing condition represents approximately a melting temperature of ice.

29. The indicator of claim 23, wherein the predetermined temperature condition relates to a significant exposure of the bimetallic disk to at least one target temperature.

30. The indicator of claim 29, wherein the predetermined temperature condition relates to a significant exposure of the bimetallic disk to the at least one target temperature for a predetermined amount of time.

31. The indicator of claim 23, wherein the predetermined temperature condition relates to a significant exposure of the bimetallic disk to at least one temperature above or below a target temperature range.

32. The indicator of claim 31, wherein the predetermined temperature condition relates to a significant exposure of the bimetallic disk to at least one temperature above or below the target temperature range for a predetermined amount of time.

33. The indicator of claim 23, wherein the housing has a substantially round shape having a diameter of less than one inch.

34. The indicator of claim 33, wherein the housing has a thickness of less than one-half an inch.

35. The indicator of claim 34, wherein the thickness of the housing is approximately one-quarter of an inch.

36. The indicator of claim 23, further including a user-operated arming mechanism having at least an unarmed state and an armed state, wherein the indicator is configured such that, in the unarmed state, the bimetallic disk is unable to cause the glass fuse to break notwithstanding changes in the physical form of the bimetallic disk and, in the armed state, the bimetallic disk is able to cause the glass fuse to break based on at least one change in the physical form of the bimetallic disk.

37. A method of indicating a temperature event associated with at least one item, comprising an act of:
a) associating at least one breakable component with the at least one item, the at least one breakable component being configured to break upon an occurrence of the temperature event.

38. The method of claim 37, wherein the at least one item is a perishable item.

39. The method of claim 37, wherein the at least one item is a consumable item.

40. The method of claim 39, wherein the at least one consumable item is for human consumption.

41. The method of claim 37, wherein the at least one item is a food item.

42. The method of claim 37, wherein the at least one item is a beverage.

43. The method of claim 37, wherein the at least one item is a medicine.

44. The method of claim 37, wherein the at least one item is a vaccine.

45. The method of claim 37, wherein the temperature event relates to a freezing of the at least one item.

46. The method of claim 37, wherein the temperature event relates to a thawing of the at least one item.

47. The method of claim 37, wherein the temperature event relates to an exposure of the at -least one item to at least one target temperature.

48. The method of claim 47, wherein the temperature event relates to an exposure of the at least one item to the at least one target temperature for a predetermined amount of time.

49. The method of claim 37, wherein the temperature event relates to an exposure of the at least one item to at least one temperature above or below a target temperature range.

50. The method of claim 49, wherein the temperature event relates to an exposure of the at least one item to at least one temperature above or below the target temperature range for a predetermined amount of time.

51. The method of claim 37, wherein the at least one item includes one item enclosed in an individual package, and wherein the act a) includes an act of:
coupling the at least one breakable component to the individual package.

52. The method of claim 37, wherein the at least one item includes one item enclosed in an individual package, and wherein the act a) includes an act of:
placing the at least one breakable component inside the individual package together with the one item.

53. The method of claim 37, wherein the at least one item includes at least two items enclosed in a group package, and wherein the act a) includes an act of:
coupling the at least one breakable component to the group package.

54. The method of claim 37, wherein the at least one item includes at least two items enclosed in a group package, and wherein the act a) includes an act of:
placing the at least one breakable component inside the group package together with the at least two items.

55. The method of claim 53, wherein the at least two items include at least two same items.

56. The method of claim 53, wherein the at least two items include at least two different items.

57. The method of claim 37, wherein the act a) includes acts of:
enclosing the at least one breakable element in an at least partially transparent housing; and
thermally associating the at least partially transparent housing with the at least one item.

58. The method of claim 37, wherein the at least one breakable element includes at least one fuse.

59. The method of claim 58, wherein the at least one fuse includes a thermal fuse.

60. The method of claim 58, wherein the at least one fuse includes a glass fuse.

61. The method of claim 58, wherein the at least one fuse is arranged with respect to at least one deformable element adapted to change its physical form based at least in part on the temperature event.

62. The method of claim 61, wherein the at least one deformable element includes at least one bimetallic disk.

63. The method of claim 61, further comprising an act of:
b) causing the at least one fuse to break upon an occurrence of the temperature event.

64. The method of claim 63, wherein the act b) includes an act of:
deforming the at least one deformable element upon the occurrence of the temperature event so as to break the at least one fuse.

65. A method for indicating if a vaccine has been frozen, comprising an act of:
a) associating at least one breakable component with the vaccine, the at least one breakable component configured to break upon an occurrence of a freezing condition of the vaccine.

66. The method of claim 65, wherein the vaccine is disposed in a protective container, and wherein the act a) includes an act of:
a1) thermally associating the at least one breakable component with the protective container.

67. The method of claim 66, wherein the act a1) includes acts of:
enclosing the at least one breakable element in an at least partially transparent housing; and
thermally coupling the at least partially transparent housing with the vaccine.

68. The method of claim 67, wherein the vaccine is disposed in multiple vials contained in a package, and wherein the act a1) further includes an act of:
placing the at least partially transparent housing enclosing the at least one breakable element inside the package together with the multiple vials of vaccine.

69. The method of claim 67, wherein the at least one breakable element includes at least one fuse.

70. The method of claim 69, wherein the at least one fuse includes a glass fuse.

71. The method of claim 70, wherein the glass fuse is arranged with respect to at least one deformable element also contained in the at least one transparent housing and adapted to change its physical form based at least in part on the freezing condition of the vaccine.

72. The method of claim 71, wherein the at least one deformable element includes at least one bimetallic disk.

73. The method of claim 72, further comprising an act of:
b) causing the at least one fuse to break upon an occurrence of the freezing condition.

74. The method of claim 73, wherein the act b) includes an act of:
deforming the at least one deformable element upon the occurrence of the freezing condition so as to break the at least one fuse.
